(19) United States
(12) Patent Application Publication
(10) Pub. No.: US 2024/0345662 A1
(43) Pub. Date: Oct. 17, 2024

(54) ELECTRONIC DEVICE, PROCESSING METHOD, AND RECORDING MEDIUM

(71) Applicant: SONY SEMICONDUCTOR SOLUTIONS CORPORATION, KANAGAWA (JP)

(72) Inventor: TSUYOSHI WATANABE, KANAGAWA (JP)

(21) Appl. No.: 18/293,757

(22) PCT Filed: Mar. 8, 2022
(86) PCT No.: PCT/JP2022/009865

§ 371 Date: Jan. 30, 2024

(30) Foreign Application Priority Data
Aug. 31, 2021 (JP) 2021-141658

(51) Int. Cl. G06F 3/01

(52) U.S. Cl. CPC G06F 3/017

(57) ABSTRACT

The present technology relates to an electronic device, a processing method, and a recording medium, which make it possible to reduce power consumption of the electronic device. An electronic device according to the present technology includes: a sensor including a first detection unit configured to detect at least a part of a body of a user; and a processor including an activation processing unit configured to execute activation processing in a case where the sensor has detected at least a part of the body. Furthermore, the processor further includes a recognition unit configured to recognize a gesture of the user on the basis of a first image captured by the sensor in a case where the sensor has detected at least a part of the body. The present technology can be applied to, for example, a smartphone that can be operated by a gesture.

### TECHNICAL FIELD

The present technology relates to an electronic device, a processing method, and a recording medium, and particularly relates to an electronic device, a processing method, and a recording medium, which make it possible to reduce power consumption of the electronic device.

### BACKGROUND ART

In recent years, a user can operate an electronic device such as a smartphone by using various operation methods. For example, Patent Document 1 discloses a technique of recognizing a gesture performed by a user, and of executing processing according to the gesture in a predetermined application.

### CITATION LIST

### Patent Document

Patent Document 1: Japanese Patent Application Laid-Open No. 2017-207890

### SUMMARY OF THE INVENTION

### Problems to be Solved by the Invention

In a case where an operation with a gesture is performed on an electronic device, since it is not known when the gesture is performed by the user, it has been necessary for an image sensor in the electronic device to constantly perform imaging, and for a processor to constantly execute gesture recognition processing.

In this way, in a case where the electronic device can be operated with a gesture, then, the processor constantly executes the gesture recognition processing, and thus power consumption of the electronic device increases.

The present technology has been made in view of such a situation, and an object thereof is to reduce power consumption of an electronic device.

### Solutions to Problems

An electronic device according to a first aspect of the present technology includes: a sensor including a first detection unit configured to detect at least a part of a body of a user; and a processor including an activation processing unit configured to execute activation processing in a case where the sensor has detected at least a part of the body.

A processing method according to the first aspect of the present technology is executed by an electronic device including a sensor and a processor, and includes: causing the sensor to detect at least a part of a body of a user; and causing the processor to execute activation processing in a case where the sensor has detected at least a part of the body.

A recording medium according to the first aspect of the present technology is recorded with a program configured to cause activation processing to be executed in a case where a sensor that detects at least a part of a body of a user has detected at least a part of the body.

An electronic device according to a second aspect of the present technology includes: a recognition unit configured to recognize a gesture of a user; and an execution unit configured to execute, in a case where processing corresponding to the gesture recognized by the recognition unit is first processing that does not require authentication of the user, the first processing.

A processing method according to the second aspect of the present technology includes causing an electronic device to recognize a gesture of a user, and execute, in a case where processing corresponding to the gesture being recognized is first processing that does not require authentication of the user, the first processing.

A recording medium according to the second aspect of the present technology is recorded with a program configured to perform recognition of a gesture of a user, and executes, in a case where processing corresponding to the gesture being recognized is first processing that does not require authentication of the user, the first processing.

In the first aspect of the present technology, the activation processing is executed in a case where the sensor that detects at least a part of a body of the user has detected at least a part of the body.

In the second aspect of the present technology, a gesture of the user is recognized, and, in a case where processing corresponding to the gesture being recognized is the first processing that does not require authentication of the user, the first processing is executed.

### BRIEF DESCRIPTION OF DRAWINGS

FIG. 1 is a diagram illustrating an example of an operation method for an electronic device according to an embodiment of the present technology.

FIG. 2 is a block diagram illustrating a hardware configuration example of the electronic device.

FIG. 3 is a block diagram illustrating a functional configuration example of a sensor and a processor of the electronic device.

FIG. 4 is a flowchart illustrating processing using a sensor and a processor of a conventional electronic device.

FIG. 5 is a flowchart illustrating processing using the sensor and the processor of the electronic device according to the present technology.

FIG. 6 is a flowchart illustrating gesture recognition processing performed by the conventional electronic device.

FIG. 7 is a diagram illustrating examples of first processing and second processing.

FIG. 8 is a flowchart illustrating gesture recognition processing performed by the electronic device according to the present technology.

FIG. 9 is a flowchart illustrating another example of the gesture recognition processing performed by the electronic device according to the present technology.

### MODE FOR CARRYING OUT THE INVENTION

Hereinafter, a mode for carrying the present technology will be described. The description will be given in the following order.
1. Configuration of Electronic Device
2. Operation of Electronic Device
3. Modifications

### 1. Configuration of Electronic Device

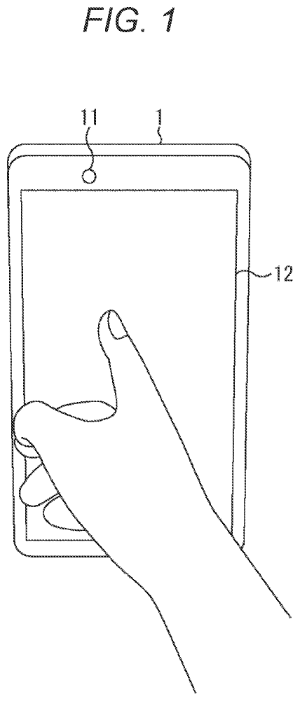

FIG. 1 is a diagram illustrating an example of an operation method for an electronic device 1 according to an embodiment of the present technology.

The electronic device 1 according to an embodiment of the present technology includes, for example, a terminal carried by a user, such as a smartphone or a tablet terminal. The electronic device 1 is provided with a sensor 11 that images at least a part of a body of the user. The sensor 11 is provided, for example, on a surface, on a side of the display 12, of the electronic device 1.

As illustrated in FIG. 1, the user can operate the electronic device 1 by performing a gesture using a hand, for example, within an angle of view of the sensor 11. The electronic device 1 recognizes the gesture performed by the user and executes processing corresponding to the gesture. For example, when a finger is pointed at the electronic device 1, the electronic device 1 replays music or stops replaying music.

In a case where processing corresponding to the gesture performed by the user is processing that does not require authentication of the user, the electronic device 1 executes the processing even in a locked state. On the other hand, in a case where processing corresponding to the gesture performed by the user is processing that requires authentication of the user, the processing is executed after the authentication of the user has succeeded, and unlocking is performed. Processing that can be executed in the locked state and processing that can be executed after unlocking is performed will be described later.

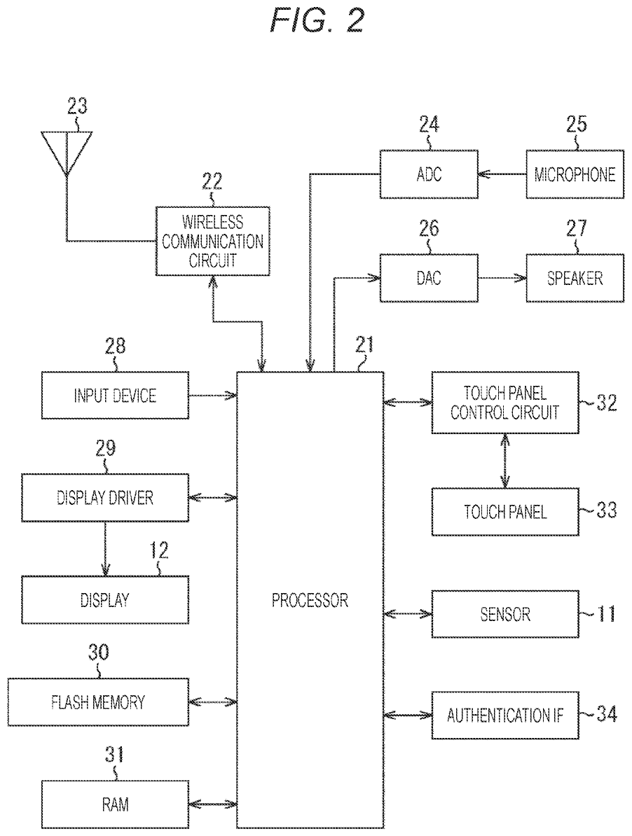

FIG. 2 is a block diagram illustrating a hardware configuration example of the electronic device 1.

As illustrated in FIG. 2, the electronic device 1 includes the sensor 11, a display 12, a processor 21, a wireless communication circuit 22, an antenna 23, an analog-to-digital converter (ADC) 24, a microphone 25, a digital-to-analog converter (DAC) 26, a speaker 27, an input device 28, a display driver 29, a flash memory 30, a random access memory (RAM) 31, a touch panel control circuit 32, a touch panel 33, and an authentication interface (IF) 34.

The processor 21 is connected with the sensor 11, the wireless communication circuit 22, the antenna 23, the ADC 24, the DAC 26, the input device 28, the display driver 29, the flash memory 30, the RAM 31, the touch panel control circuit 32, and the authentication IF 34.

The processor 21 includes an application processor (AP) or the like. The processor 21 controls the electronic device 1 entirely. All or some of programs installed in advance in the flash memory 30 are deployed in the random access memory (RAM) 31, when used, and the processor 21 operates according to the programs on the RAM 31. Note that the RAM 31 is used as a working region or a buffer region for the processor 21.

For example, as the user performs an operation of executing a desired application, the processor 21 executes a program corresponding to the application. As a result, the user can use the application.

The wireless communication circuit 22 is a circuit for transmitting and receiving radio waves for voice calls, mails, and the like through the antenna 23.

The ADC 24 is connected with the microphone 25. An audio signal sent from the microphone 25 is converted into digital audio data by the ADC 24 and supplied to the processor 21.

The DAC 26 is connected with the speaker 27. The DAC 26 converts digital audio data into an audio signal and supplies the audio signal to the speaker 27 via an amplifier. With this configuration, a voice corresponding to the audio data is output from the speaker 27.

The input device 28 includes a button and the like. Information indicating an operation of the user, which is input from the input device 28, is supplied to the processor 21.

The display driver 29 is connected to the display 12. The display driver 29 causes a video RAM (VRAM), for example, to store image data supplied from the processor 21, and causes the display 12 to display an image corresponding to the data stored in the VRAM.

The touch panel control circuit 32 is connected with the touch panel 33. The touch panel control circuit 32 supplies necessary electric power and the like to the touch panel 33, and further supplies, to the processor 21, a start signal indicating start of a touch performed by the user on the touch panel 33, an end signal indicating end of the touch performed by the user, and coordinate data indicating a position of the touch, at which the user is touching. Therefore, the processor 21 can determine an icon or the like operated by the user on the basis of the coordinate data.

The authentication IF 34 detects biometric information such as a fingerprint, a vein, a palm print, a palm shape, an iris, and the like used for biometric authentication of the user, and supplies a result of the detection of the biometric information to the processor 21. The processor 21 can perform authentication of the user on the basis of the biometric information detected by the authentication IF 34. Note that, in the biometric information, a vein and a palm print may be acquired from image data supplied from the signal processing unit 53.

The sensor 11 includes a charge coupled device (CCD) image sensor, a complementary metal oxide semiconductor (CMOS) image sensor, or the like. The sensor 11 performs imaging and detects at least a part of the body of the user, which is used for performing a gesture. In response to detection of a part of the body of the user by the sensor 11, the processor 21 is activated. Hereinafter, it is assumed that the user performs a gesture using a hand. Note that a gesture may be performed using a part of the body other than a hand, such as the face, eyes, or mouth.

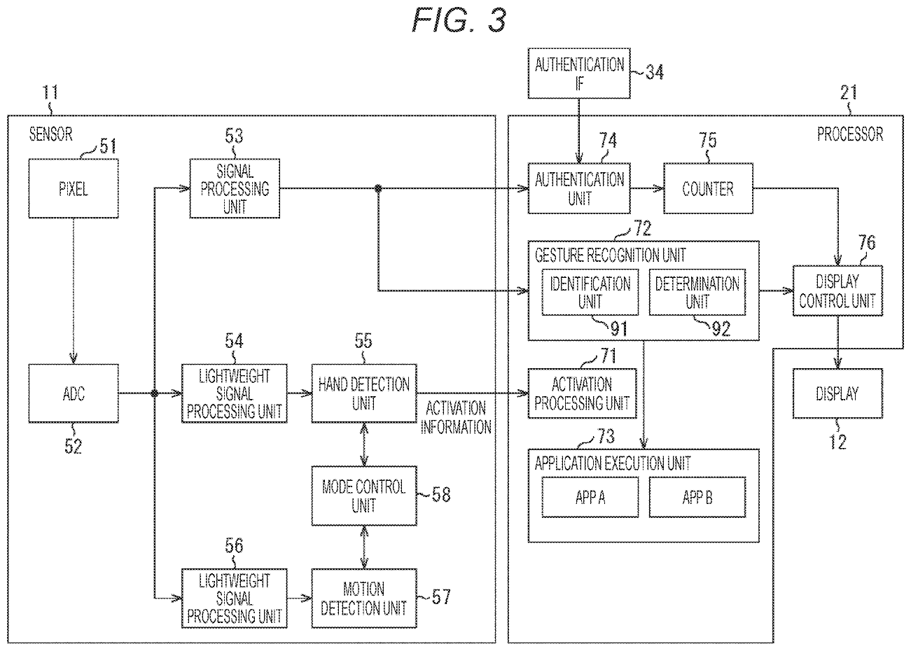

FIG. 3 is a block diagram illustrating a functional configuration example of the sensor 11 and the processor 21 of the electronic device 1.

As illustrated in FIG. 3, the sensor 11 includes a pixel 51, an ADC 52, a signal processing unit 53, a lightweight signal processing unit 54, a hand detection unit 55, a lightweight signal processing unit 56, a motion detection unit 57, and a mode control unit 58.

The pixel 51 accumulates signal electric charges corresponding to an amount of light of incident light, and supplies the signal electric charges to the ADC 52.

The ADC 52 converts the signal electric charges supplied from the pixel 51 into a digital image signal, and supplies the digital image signal to the signal processing unit 53, the lightweight signal processing unit 54, and the lightweight signal processing unit 56.

The signal processing unit 53 performs signal processing on the image signal supplied from the ADC 52. Specifically, the signal processing unit 53 performs processing such as defect correction, noise reduction, development processing, and the like on the image signal to generate image data. The signal processing unit 53 supplies the generated image data to the gesture recognition unit 72 and the authentication unit 74 of the processor 21.

The lightweight signal processing unit 54 performs lightweight signal processing of generating image data used for detecting a hand with low electric power on the image signal supplied from the ADC 52. Specifically, for example, the lightweight signal processing unit 54 performs processing excluding defect correction, among various signal processing performed by the signal processing unit 53, on the image signal to generate image data. The lightweight signal processing unit 54 supplies the generated image data to the hand detection unit 55.

Furthermore, in order to cause the hand detection unit 55 to operate with low electric power, the lightweight signal processing unit 54 may perform down-conversion or the like on image data. As described above, the lightweight signal processing unit 54 generates image data that is lower in definition than image data generated by the signal processing unit 53. Such low-definition image data used in here includes image data having a defect, noise, or the like, and includes low-resolution image data.

The hand detection unit 55 detects a hand appearing in image data supplied from the lightweight signal processing unit 54. Detection of a hand by the hand detection unit 55 may be performed using artificial intelligence (AI) or may be performed using a rule-based method. In a case where a hand is detected, the hand detection unit 55 supplies activation information for activating the processor 21 to the activation processing unit 71 of the processor 21. Furthermore, the hand detection unit 55 supplies information indicating a result of the detection of the hand to the mode control unit 58.

The lightweight signal processing unit 56 performs lightweight signal processing of generating image data used for detecting a motion of a user with low electric power on the image signal supplied from the ADC 52. Specifically, for example, the lightweight signal processing unit 56 performs processing excluding defect correction, among various signal processing performed by the signal processing unit 53, on the image signal to generate image data. The lightweight signal processing unit 56 supplies the generated image data to the motion detection unit 57.

Furthermore, in order to cause the motion detection unit 57 to operate with low electric power, the lightweight signal processing unit 56 may perform down-conversion or the like to reduce the number of pixels in image data to be smaller than the number of pixels in image data generated by the lightweight signal processing unit 54. As described above, the lightweight signal processing unit 56 generates image data that is lower in definition than image data generated by the lightweight signal processing unit 54. Note that the lightweight signal processing unit 54 and the lightweight signal processing unit 56 may perform signal processing identical to signal processing performed by the signal processing unit 53, instead of performing the lightweight signal processing.

The motion detection unit 57 detects a motion of the user, which is appearing in image data supplied from the lightweight signal processing unit 56. Detection of a motion of the user by the motion detection unit 57 may be performed using AI or may be performed using a rule-based method. In a case where a motion of the user is detected, the motion detection unit 57 supplies information indicating a result of the detection of the motion to the mode control unit 58.

The mode control unit 58 sets the sensor 11 into a hand detection mode, a motion detection mode, or a normal processing mode on the basis of a result of detection of a hand by the hand detection unit 55 or a result of detection of a motion by the motion detection unit 57.

For example, in a case where a motion of the user is detected by the motion detection unit 57, the mode control unit 58 sets the sensor 11 into the hand detection mode. In a case where the sensor 11 is set into the hand detection mode, the lightweight signal processing unit 54 and the hand detection unit 55 operate, and the lightweight signal processing unit 56 and the motion detection unit 57 do not operate.

For example, in a case where a hand is not detected by the hand detection unit 55, the mode control unit 58 sets the sensor 11 into the motion detection mode. In a case where the sensor 11 is set into the motion detection mode, the lightweight signal processing unit 56 and the motion detection unit 57 operate, and the lightweight signal processing unit 54 and the hand detection unit 55 do not operate.

In the processor 21, an activation processing unit 71, a gesture recognition unit 72, an application execution unit 73, an authentication unit 74, a counter 75, and a display control unit 76 are implemented.

In a case where activation information is supplied from the hand detection unit 55, the activation processing unit 71 performs activation processing and activates the processor 21.

The gesture recognition unit 72 recognizes a gesture of the user on the basis of image data supplied from the signal processing unit 53. The gesture recognition unit 72 includes an identification unit 91 and a determination unit 92.

The identification unit 91 identifies a type of the gesture of the user on the basis of the image data.

The determination unit 92 determines whether or not the gesture performed by the user is a gesture corresponding to processing that requires authentication of the user or a gesture corresponding to processing that does not require authentication of the user.

The gesture recognition unit 72 causes the application execution unit 73 to execute processing according to the gesture performed by the user in each application. The gesture recognition unit 72 supplies a result of the recognition of the gesture to the display control unit 76.

In a case where the determination unit 92 determines that the gesture performed by the user is a gesture corresponding to processing that requires authentication of the user, the application execution unit 73 executes, for example, predetermined processing in an app (application) A. In a case where the determination unit 92 determines that the gesture performed by the user is a gesture corresponding to processing that does not require authentication of the user, the application execution unit 73 executes, for example, predetermined processing in an app B.

The authentication unit 74 authenticates the user on the basis of biometric information of the user detected by the authentication IF 34. Furthermore, the authentication unit 74 performs, on the basis of image data supplied from the signal processing unit 53, authentication of the user based on face authentication or hand authentication representing authentication using a palm print or vein. In a case where authentication of the user has succeeded, for example, the authentication unit 74 performs unlocking of the electronic device 1. The authentication unit 74 supplies a result of the authentication to the counter 75.

The counter 75 counts the number of times authentication by the authentication unit 74 has failed. In a case where authentication by the authentication unit 74 has failed, the counter 75 supplies information indicating that authentication has failed to the display control unit 76 together with information indicating the number of times the authentication has failed.

The display control unit 76 causes the display 12 to display an alert on the basis of a result of the recognition of the gesture by the gesture recognition unit 72. For example, in a case where the identification unit 91 cannot identify a type of a gesture, the display 12 is caused to display an alert indicating that the type of the gesture cannot be identified.

The display control unit 76 causes the display 12 to display an alert on the basis of a result of the authentication of the user by the authentication unit 74. For example, in a case where authentication of the user by the authentication unit 74 has failed, the display 12 is caused to display an alert indicating that the authentication has failed.

### 2. Operation of Electronic Device

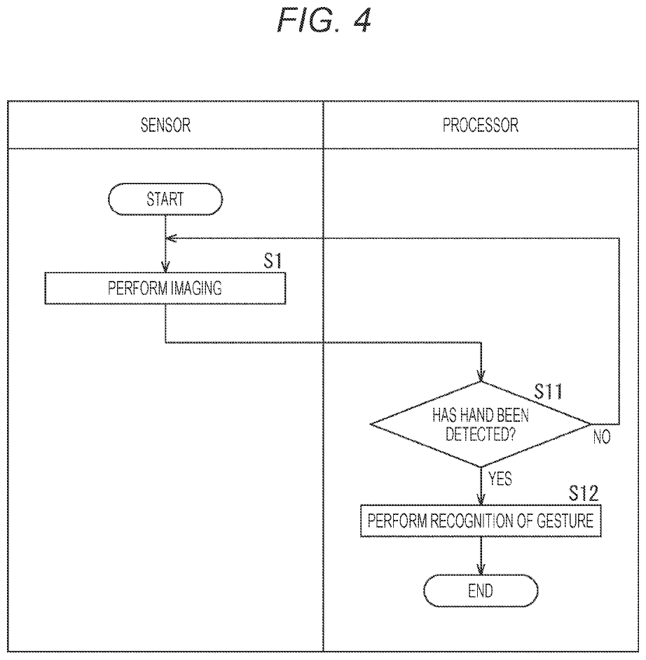

Here, before a flow of operation of the electronic device 1 according to the present technology is described, a flow of operation of recognizing a gesture in a conventional electronic device will be described. Processing using a sensor and a processor of a conventional electronic device will be described with reference to a flowchart illustrated in FIG. 4.

In step S1, the sensor performs imaging.

In step S11, the processor detects a hand appearing in image data captured and acquired by the sensor, and determines whether or not a hand has been detected.

In a case where it is determined in step S11 that a hand is not detected, the processing returns to step S1, and imaging by the sensor is repeatedly performed.

In a case where it is determined in step S11 that a hand is detected, the processor recognizes a gesture on the basis of image data in step S12.

As described above, in the conventional electronic device, the processor constantly detects a hand, and recognizes a gesture in a case where a hand is detected.

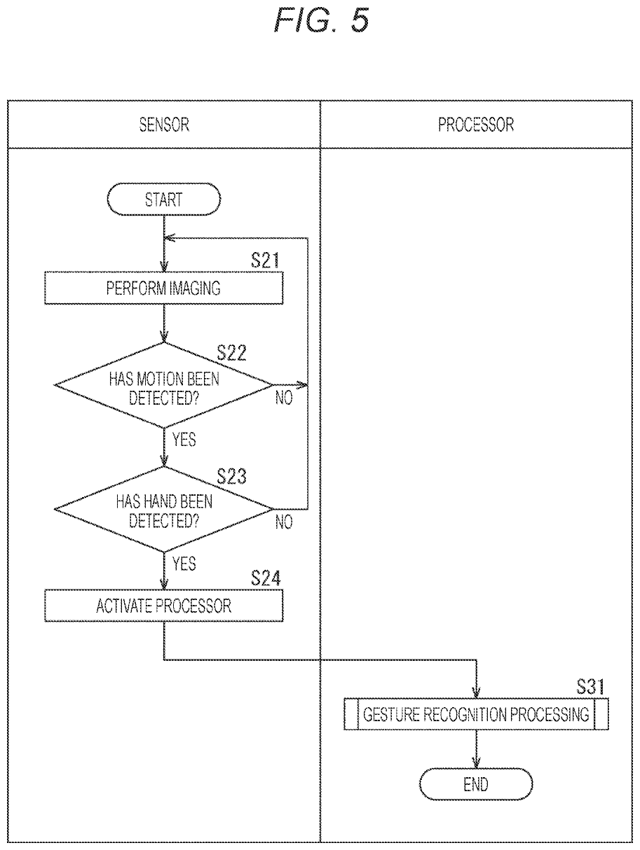

Next, processing of the sensor 11 and the processor 21 of the electronic device 1 according to the present technology will be described with reference to a flowchart illustrated in FIG. 5. The processing illustrated in FIG. 5 starts in a state where the sensor 11 is set into the motion detection mode.

In step S21, the sensor 11 performs imaging. Here, for example, signal electric charges that are output from the pixel 51 of the sensor 11 are converted into an image signal by the ADC 52, and the lightweight signal processing unit 56 performs lightweight signal processing on the image signal to generate image data.

In step S22, the motion detection unit 57 of the sensor 11 performs detection of a motion of the user appearing in the image data generated by the lightweight signal processing unit 56, and determines whether or not a motion is detected.

In a case where it is determined in step S22 that a motion of the user is not detected, the processing returns to step S21 to perform subsequent steps.

In a case where it is determined in step S22 that a motion of the user is detected, the mode control unit 58 sets the sensor 11 into the hand detection mode. For example, the lightweight signal processing is performed by the lightweight signal processing unit 54 of the sensor 11 on an image signal of a frame next to a frame in which the motion of the user has been detected, and image data is generated. Thereafter, in step S23, the hand detection unit 55 of the sensor 11 performs detection of a hand appearing in the image data generated by the lightweight signal processing unit 54, and determines whether or not a hand is detected.

In a case where it is determined in step S23 that a hand is not detected, the processing returns to step S21, the mode control unit 58 sets the sensor 11 into the motion detection mode again to repeatedly perform subsequent steps.

In a case where it is determined in step S23 that a hand is detected, the mode control unit 58 sets the sensor 11 into the normal processing mode. In the normal processing mode, for example, signal processing is performed by the signal processing unit 53 of the sensor 11 on an image signal of a frame next to a frame in which the hand has been detected, and image data is generated. Thereafter, in step S24, the hand detection unit 55 of the sensor 11 supplies activation information to the activation processing unit 71 of the processor 21 to activate the processor 21.

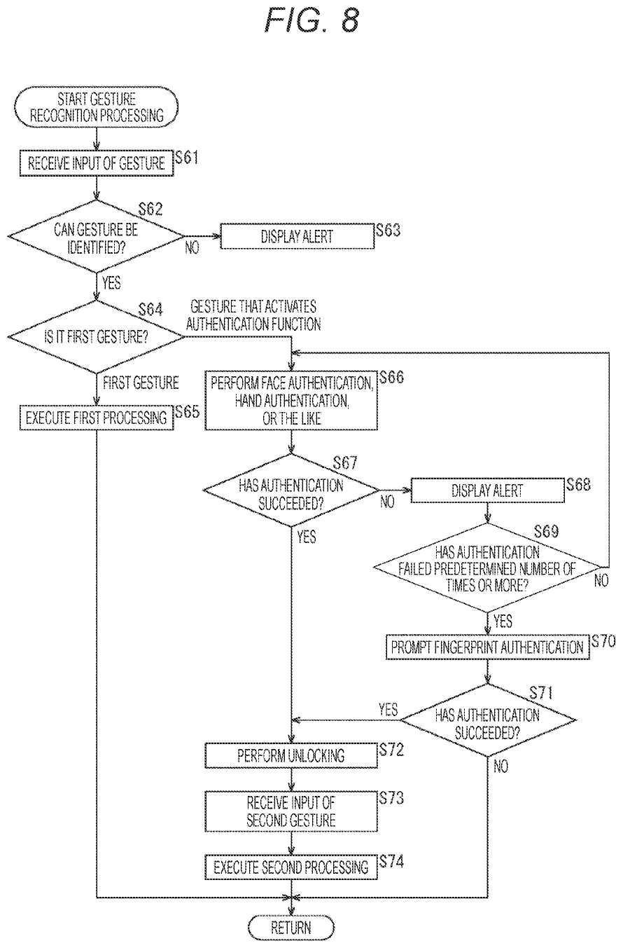

In step S31, the processor 21 performs the gesture recognition processing on the basis of the image data generated by the signal processing unit 53. A gesture of the user is recognized through the gesture recognition processing, and processing corresponding to the gesture is executed. Details of the gesture recognition processing will be described later with reference to FIG. 8.

As described above, in the electronic device 1 according to the present technology, detection of a motion or detection of a hand is constantly performed by the sensor 11, and a power supply to the processor 21 is turned off until a hand is detected. As a hand is detected, the processor 21 is activated, and recognition of a gesture is performed by the processor 21. By turning off the power supply to the processor 21 until a hand is detected by the sensor 11, it is possible to reduce power consumption of the entire electronic device 1.

Furthermore, the sensor 11 can detect a hand with low electric power by using image data generated by allowing an image signal to undergo the lightweight signal processing. By using image data that is lower in definition than image data used to detect a hand, the sensor 11 can detect a motion of the user with lower electric power. Since detection of a hand is not performed until a motion of the user is detected, power consumption of the sensor 11 can be reduced.

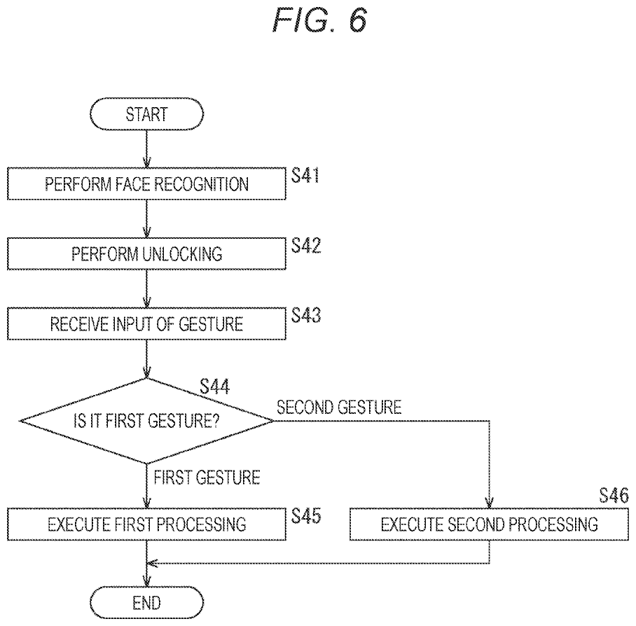

Here, before the gesture recognition processing performed by the processor 21 according to the present technology is described, gesture recognition processing performed by a conventional electronic device will be described. The gesture recognition processing performed by the conventional electronic device will be described with reference to a flowchart illustrated in FIG. 6.

In step S41, the processor authenticates the user through face authentication on the basis of image data captured and acquired by the sensor.

In step S42, in a case where authentication of the user has succeeded, the processor performs unlocking of the electronic device.

In step S43, the processor receives an input of a gesture.

In step S44, the processor determines whether or not the gesture performed by the user is a first gesture. Hereinafter, it is assumed that the first gesture is a gesture corresponding to first processing that is processing with low security importance, and a second gesture is a gesture corresponding to a second gesture that is processing with high security importance. In a case where it is determined in step S44 that the gesture performed by the user is the first gesture, the processor executes, for example, the first processing corresponding to the first gesture.

In a case where it is determined in step S44 that the gesture performed by the user is the second gesture, the processor executes, for example, the second processing corresponding to the second gesture.

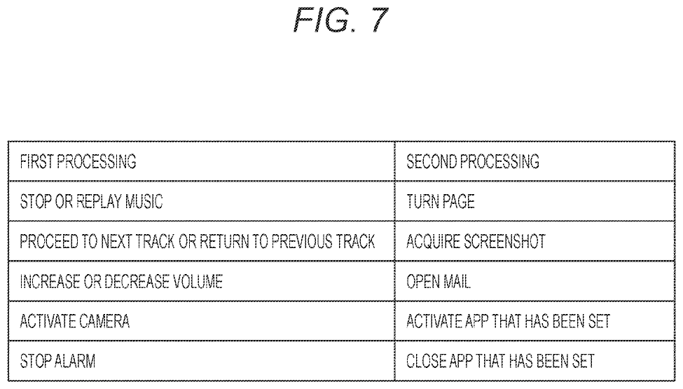

FIG. 7 is a diagram illustrating examples of the first processing and the second processing.

As illustrated on the left side in FIG. 7, the examples of the first processing include processing of stopping replaying music, replaying music, proceeding to replaying a next track, returning to replaying a previous track, increasing or decreasing volume, activating camera, and stopping alarm.

As illustrated on the right side in FIG. 7, the examples of the second processing include processing of turning page, acquiring screenshot, opening mail, activating application that has been set, and closing application that has been set.

As described above, in the conventional electronic device, after authentication of a user has succeeded and unlocking of the electronic device is performed, an input of either the first gesture or the second gesture is received. Therefore, even in a case where the first gesture corresponding to the first processing with low security importance is performed, the user needs to perform the gesture after performing unlocking of the electronic device. As described above, an effort of the user has been required to perform unlocking of the electronic device before performing the first gesture for the processing with low security importance.

Next, the gesture recognition processing performed by the electronic device 1 according to the present technology will be described with reference to a flowchart illustrated in FIG. 8. The gesture recognition processing illustrated in FIG. 8 is processing performed in step S31 in FIG. 5.

In step S61, the gesture recognition unit 72 receives an input of a gesture.

In step S62, the identification unit 91 determines whether or not a type of the gesture performed by the user can be identified. Here, it is determined whether or not a type of the gesture performed by the user can be identified as a gesture corresponding to processing that can be executed before unlocking is performed. For example, the first gesture or a gesture that activates the authentication function is identified as a gesture corresponding to processing that can be performed before unlocking is performed.

In a case where it is determined in step S62 that a type of the gesture cannot be identified, that is, in a case where recognition of a gesture has failed, the display control unit 76 causes the display 12 to display an alert indicating that a type of the gesture cannot be identified in step S63.

In a case where it is determined in step S62 that a type of the gesture can be identified, the determination unit 92 determines whether or not the gesture performed by the user is the first gesture in step S64.

In a case where it is determined in step S64 that the gesture performed by the user is the first gesture, the application execution unit 73 executes the first processing corresponding to the first gesture. Thereafter, the processing returns to step S31 in FIG. 5 to perform subsequent steps.

In a case where it is determined in step S64 that the gesture performed by the user is a gesture for activating the authentication function, the authentication unit 74 authenticates the user in step S66 by a non-contact type method such as face authentication, hand authentication, or the like on the basis of image data captured and acquired by the sensor 11. Note that a user may be authenticated by a non-contact type authentication method based on biometric information detected by the authentication IF 34 or through voiceprint authentication based on a voice of the user, which is collected by the microphone 25.

In step S67, the authentication unit 74 determines whether or not the authentication has succeeded.

In a case where it is determined in step S67 that authentication has failed, the display control unit 76 causes the display 12 to display an alert indicating that the authentication has failed in step S68.

In step S69, the display control unit 76 determines whether or not authentication has failed a predetermined number of times or more on the basis of information provided from the counter 75.

In a case where it is determined in step S69 that the number of times that authentication has failed is less than a predetermined number of times, the processing returns to step S66 to perform subsequent steps.

In a case where it is determined in step S69 that authentication has failed the predetermined number of times or more, the display control unit 76 causes the display 12 to display information indicating prompting of fingerprint authentication in step S70. Here, information indicating prompting of a contact-type authentication method different from the authentication method used in step S66 and the like is displayed on the display 12. Thereafter, the authentication unit 74 authenticates the user through fingerprint authentication.

In step S71, it is determined whether or not authentication of the user through fingerprint authentication has succeeded.

In a case where it is determined in step S71 that authentication of the user through fingerprint authentication has failed, the processing returns to step S31 in FIG. 5 to perform subsequent steps.

In a case where it is determined in step S71 that authentication of the user through fingerprint authentication has succeeded, the processing proceeds to step S72. Similarly, in a case where it is determined in step S67 that authentication of the user through face authentication, hand authentication, or the like has succeeded, the processing proceeds to step S72.

In step S72, the authentication unit 74 performs unlocking of the electronic device 1.

In step S73, the gesture recognition unit 72 receives an input of the second gesture. In other words, the gesture recognition unit 72 recognizes the second gesture after authentication of the user has succeeded. Note that an input of the first gesture may be received after unlocking of the electronic device 1 is performed.

In step S74, the application execution unit 73 executes the second processing corresponding to the second gesture. Thereafter, the processing returns to step S31 in FIG. 5 to perform subsequent steps.

Note that, in the electronic device 1 according to the present technology, the first processing as described with reference to FIG. 7 is executed as processing that does not require authentication, and the second processing is executed as processing that requires authentication. Each of the processing that requires authentication and the processing that does not require authentication may be set in advance by the user.

As described above, in the electronic device 1 according to the present technology, before unlocking of the electronic device 1 is performed, an input of the first gesture is received, and the first processing is executed. Furthermore, in the electronic device 1 according to the present technology, after the user performs a gesture of activating the authentication function and unlocking of the electronic device 1 is performed, an input of the second gesture is received, and the second processing is executed.

Therefore, the user can perform the first gesture corresponding to the first processing that does not require authentication before performing unlocking of the electronic device 1 to cause the first processing to be executed. With this configuration, it is possible to reduce an effort of the user to perform unlocking of the electronic device 1 before performing the first gesture, for example.

### 3. Modifications

### Timing of Receiving Input of Second Gesture

Before unlocking is performed, an input of either the first gesture or the second gesture may be received.

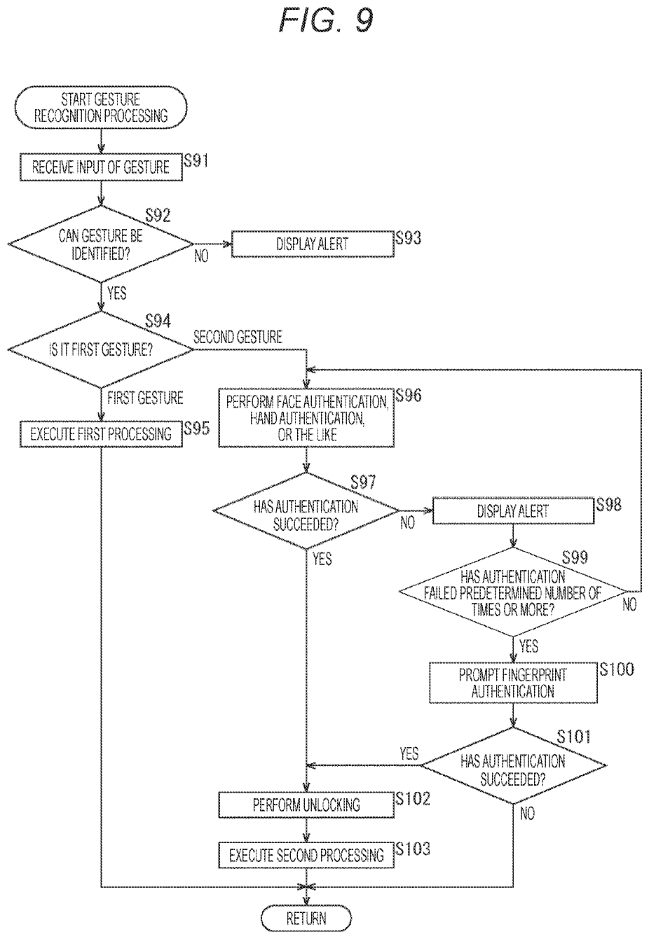

Another example of the gesture recognition processing performed in step S31 in FIG. 5 will be described with reference to a flowchart illustrated in FIG. 9.

In step S91, the gesture recognition unit 72 receives an input of a gesture.

In step S92, the identification unit 91 determines whether or not a type of the gesture performed by the user can be identified. Here, it is determined whether or not a type of the gesture performed by the user can be identified as a gesture corresponding to processing that can be executed before or after unlocking is performed. For example, the first gesture or the second gesture is identified as a gesture corresponding to processing that can be performed before or after unlocking is performed.

In a case where it is determined in step S92 that a type of the gesture cannot be identified, the display control unit 76 causes the display 12 to display an alert indicating that a type of the gesture cannot be identified in step S93.

In a case where it is determined in step S92 that a type of the gesture can be identified, the determination unit 92 determines whether or not the gesture performed by the user is the first gesture in step S94.

In a case where it is determined in step S94 that the gesture performed by the user is the first gesture, the application execution unit 73 executes the first processing. Thereafter, the processing returns to step S31 in FIG. 5 to perform subsequent steps.

In a case where it is determined in step S94 that the gesture performed by the user is the second gesture, the processing proceeds to step S96. The processing in steps S96 to S102 is similar to the processing in steps S66 to S72 in FIG. 8. Through the processing in steps S96 to S102, authentication of the user is performed, and, in a case where the authentication has succeeded, unlocking of the electronic device 1 is performed.

After unlocking of the electronic device 1 is performed, the application execution unit 73 executes the second processing in step S103. Thereafter, the processing returns to step S31 in FIG. 5 to perform subsequent steps.

As described above, an input of the second gesture can be received before unlocking is performed. In other words, before authentication of the user is performed, recognition of the second gesture is performed. Even in this case, after unlocking is performed, the second processing corresponding to the second gesture is executed.

### Others

Sensors different from the image sensor, such as an illuminance sensor, a proximity sensor, and a distance sensor, may be provided in the electronic device 1, and a plurality of sensors including these sensors and the sensor 11 may each take a role of detecting a motion or a hand of the user.

A series of the processing described above can be executed by hardware or can be executed by software. In a case where the series of the processing is executed by software, a program constituting the software is installed to a computer incorporated in dedicated hardware, a general-purpose personal computer, or the like.

The program to be installed is provided by being recorded in an optical disk (compact disc-read only memory (CD-ROM), digital versatile disc (DVD), or the like), a flash memory including a semiconductor memory, or the like. Furthermore, the program may be provided via a wired or wireless transmission medium such as a local area network, the Internet, or digital broadcasting. The program can be installed in advance in the flash memory 30 illustrated in FIG. 2.

Note that the program executed by the computer may be a program configured to perform processing in a time-series manner in the order described in the present specification, or may be a program configured to perform processing in parallel or at necessary timing such as when a call is made.

Note that the effects described in the present specification are merely examples and are not limited, and there may be other effects.

Embodiments of the present technology are not limited to the above-described embodiment, and various modifications may be made without departing from the gist of the present technology.

For example, the present technology can have a cloud computing configuration in which one function is shared and processed in cooperation by a plurality of devices via a network.

Furthermore, each of the steps described in the above-described flowcharts can be executed by one device or executed by a plurality of devices in a shared manner.

Moreover, in a case where a plurality of processing is included in one step, the plurality of processing included in the one step can be executed by one device or executed by a plurality of devices in a shared manner.

### Examples of Combinations of Configurations

The present technology may also have the following configurations.
(1)

An electronic device including:
a sensor including a first detection unit configured to detect at least a part of a body of a user; and
a processor including an activation processing unit configured to execute activation processing in a case where the sensor has detected at least a part of the body.
(2)

The electronic device described in (1) above, in which
the processor further includes a recognition unit configured to recognize a gesture of the user on the basis of a first image captured by the sensor in a case where the sensor has detected at least a part of the body.
(3)

The electronic device described in (2) above, in which
the sensor further includes a second detection unit configured to detect a motion of the user, and
the first detection unit detects at least a part of the body of the user in a case where the second detection unit has detected a motion of the user.
(4)

The electronic device described in (3) above, in which
the sensor detects at least a part of the body, the part of the body being captured in a second image that is lower in definition than the first image.
(5)

The electronic device described in (4) above, in which
the sensor detects a motion of the user, the motion of the user appearing in a third image that is lower in definition than the second image.
(6)

The electronic device described in any one of (1) to (5) above, in which
the electronic device is a terminal carried by the user.
(7)

A processing method executed by an electronic device including
a sensor and
a processor,
the method including:
causing the sensor to detect at least a part of a body of a user; and
causing the processor to execute activation processing in a case where the sensor has detected at least a part of the body.
(8)

A recording medium that is readable by a computer, the recording medium being recorded with a program configured to
cause activation processing to be executed in a case where a sensor that detects at least a part of a body of a user has detected at least a part of the body.
(9)

An electronic device including:
a recognition unit configured to recognize a gesture of a user; and
an execution unit configured to execute, in a case where processing corresponding to the gesture recognized by the recognition unit is first processing that does not require authentication of the user, the first processing.
(10)

The electronic device described in (9) above, in which
the execution unit executes, in a case where processing corresponding to the gesture recognized by the recognition unit is second processing that requires authentication of the user, the second processing after the authentication of the user has succeeded.
(11)

The electronic device described in (10) above, in which
the recognition unit recognizes the gesture corresponding to the second processing after the authentication of the user has succeeded.
(12)

The electronic device described in (10) above, in which
the recognition unit recognizes the gesture corresponding to the second processing before performing authentication of the user.
(13)

The electronic device described in any one of (10) to (12) above, in which
the execution unit executes the second processing in a case where authentication of the user by a first authentication method has succeeded at the number of times less than a predetermined number of times.
(14)

The electronic device described in (13) above, in which
the execution unit executes, in a case where authentication of the user by the first authentication method has failed a predetermined number of times or more, the second processing after the authentication of the user by a second authentication method has succeeded.
(15)

The electronic device described in any one of (9) to (14) above, further including
a presentation unit that presents an alert in a case where recognition of the gesture has failed or authentication of the user has failed.
(16)

The electronic device described in any one of (9) to (15) above, in which
the electronic device is a terminal carried by the user.
(17)

The electronic device described in any one of (9) to (16) above, further including:
a sensor configured to detect at least a part of a body of a user; and
a processor configured to execute activation processing in a case where the sensor has detected at least a part of the body,
the processor including the recognition unit.
(18)

A processing method including causing an electronic device to
recognize a gesture of a user, and
execute, in a case where processing corresponding to the gesture being recognized is first processing that does not require authentication of the user, the first processing.
(19)

A recording medium that is readable by a computer, the recording medium being recorded with a program configured to
perform recognition of a gesture of a user, and
execute, in a case where processing corresponding to the gesture being recognized is first processing that does not require authentication of the user, the first processing.

### REFERENCE SIGNS LIST

1 Electronic device
11 Sensor
12 Display
21 Processor
34 Authentication IF
51 Pixel
52 ADC
53 Signal processing unit
54 Lightweight signal processing unit
55 Hand detection unit
56 Lightweight signal processing unit
57 Motion detection unit
58 Mode control unit
71 Activation processing unit
72 Gesture recognition unit
73 Application execution unit
74 Authentication unit
75 Counter
76 Display control unit
91 Identification unit
92 Determination unit

1. An electronic device comprising:
a sensor including a first detection unit configured to detect at least a part of a body of a user; and
a processor including an activation processing unit configured to execute activation processing in a case where the sensor has detected at least a part of the body.

2. The electronic device according to claim 1, wherein the processor further includes
a recognition unit configured to recognize a gesture of the user on a basis of a first image captured by the sensor in a case where the sensor has detected at least a part of the body.

3. The electronic device according to claim 2,
wherein the sensor further includes a second detection unit configured to detect a motion of the user, and
the first detection unit detects at least a part of the body of the user in a case where the second detection unit has detected a motion of the user.

4. The electronic device according to claim 3,
wherein the sensor detects at least a part of the body, the part of the body being captured in a second image that is lower in definition than the first image.

5. The electronic device according to claim 4,
wherein the sensor detects a motion of the user, the motion of the user appearing in a third image that is lower in definition than the second image.

6. The electronic device according to claim 1,
wherein the electronic device is a terminal carried by the user.

7. A processing method executed by an electronic device including
a sensor and
a processor,
the method comprising:
causing the sensor to detect at least a part of a body of a user; and
causing the processor to execute activation processing in a case where the sensor has detected at least a part of the body.

8. A recording medium that is readable by a computer, the recording medium being recorded with a program configured to
cause activation processing to be executed in a case where a sensor that detects at least a part of a body of a user has detected at least a part of the body.

9. An electronic device comprising:
a recognition unit configured to recognize a gesture of a user; and
an execution unit configured to execute, in a case where processing corresponding to the gesture recognized by the recognition unit is first processing that does not require authentication of the user, the first processing.

10. The electronic device according to claim 9,
wherein the execution unit executes, in a case where processing corresponding to the gesture recognized by the recognition unit is second processing that requires authentication of the user, the second processing after the authentication of the user has succeeded.

11. The electronic device according to claim 10,
wherein the recognition unit recognizes the gesture corresponding to the second processing after the authentication of the user has succeeded.

12. The electronic device according to claim 10,
wherein the recognition unit recognizes the gesture corresponding to the second processing before performing the authentication of the user.

13. The electronic device according to claim 10,
wherein the execution unit executes the second processing in a case where authentication of the user by a first authentication method has succeeded at a number of times less than a predetermined number of times.

14. The electronic device according to claim 13,
wherein the execution unit executes, in a case where authentication of the user by the first authentication method has failed a predetermined number of times or more, the second processing after the authentication of the user by a second authentication method has succeeded.

15. The electronic device according to claim 9, further comprising
a presentation unit that presents an alert in a case where recognition of the gesture has failed or authentication of the user has failed.

16. The electronic device according to claim 9,
wherein the electronic device is a terminal carried by the user.

17. The electronic device according to claim 9, further comprising:
a sensor configured to detect at least a part of a body of a user; and
a processor configured to execute activation processing in a case where the sensor has detected at least a part of the body,
the processor including the recognition unit.

18. A processing method comprising causing an electronic device to
recognize a gesture of a user, and
execute, in a case where processing corresponding to the gesture being recognized is first processing that does not require authentication of the user, the first processing.

19. A recording medium that is readable by a computer, the recording medium being recorded with a program configured to
perform recognition of a gesture of a user, and
execute, in a case where processing corresponding to the gesture being recognized is first processing that does not require authentication of the user, the first processing.
